(19) United States
(12) Patent Application Publication
(10) Pub. No.: US 2026/0251097 A1
(43) Pub. Date: Aug. 27, 2026

(54) CONTROL DEVICE

(71) Applicant: HONDA MOTOR CO., LTD., Tokyo (JP)

(72) Inventors: Hisashi DAICHO, Tokyo (JP); Hiroki ISHIKAWA, Tokyo (JP)

(73) Assignee: HONDA MOTOR CO., LTD., Tokyo (JP)

(21) Appl. No.: 19/544,568

(22) Filed: Feb. 19, 2026

(30) Foreign Application Priority Data
Feb. 25, 2025 (JP) 2025-027845

(51) Int. Cl. F02D 31/00; F02D 41/00; F02D 41/14

(52) U.S. Cl. CPC F02D 31/002; F02D 31/007; F02D 41/0007; F02D 41/1454; F02D 2200/101; F02D 2200/602

(57) ABSTRACT

A control device that controls a vehicle capable of traveling by driving a drive wheel with an output of an engine includes a processor configured to limit a maximum output of the engine to a predetermined limit value, acquire information indicating a current position of the vehicle, and determine whether the processor can release limitation on the maximum output based on the information indicating the current position acquired by the processor. The processor determines that the limitation can be released when the current position is determined to be within a predetermined area, and determines that the limitation cannot be released when the current position is determined to be outside the predetermined area. When the processor determines that the limitation can be released, the processor releases the limitation and increases the maximum output to a value larger than the limit value.

### CROSS-REFERENCE TO RELATED APPLICATIONS

This application is based on and claims priority under 35 USC 119 from Japanese Patent Application No. 2025-027845 filed on February 25, 2025, the entire content of which is incorporated herein by reference.

### TECHNICAL FIELD

The present disclosure relates to a control device that controls a vehicle capable of traveling by driving a drive wheel with an output of an engine.

### BACKGROUND ART

In recent years, as a specific countermeasure against global climate change, efforts toward realization of a low-carbon society or a decarbonized society are activated. A reduction in CO₂ emission and an improvement in energy efficiency are also required for vehicles such as automobiles, and research and development for realizing the reduction and the improvement are performed.

JP4989770B discloses a technique in which the maximum speed of a vehicle is limited to an initial set value when it is determined that a vehicle position is not located within a non-public road area, and the limitation of the initial set value is released when it is determined that the vehicle position is located within the non-public road area.

### SUMMARY OF INVENTION

However, in the related art, there is no sufficient study on changing engine characteristics according to the current position of the vehicle, so there is room for improvement in this respect.

Aspects of non-limiting embodiments of the present disclosure relates to a control device capable of improving drivability by changing engine characteristics according to a current position of a vehicle.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a control device that controls a vehicle capable of traveling by driving a drive wheel with an output of an engine, the control device including a processor configured to limit a maximum output of the engine to a predetermined limit value, acquire information indicating a current position of the vehicle, and determine whether the processor can release limitation on the maximum output based on the information indicating the current position acquired by the processor, in which the processor determines that the limitation can be released when the current position is determined to be within a predetermined area, and determines that the limitation cannot be released when the current position is determined to be outside the predetermined area, and when the processor determines that the limitation can be released, the processor releases the limitation and increases the maximum output to a value larger than the limit value.

According to an aspect of the present disclosure, it is possible to provide a control device capable of improving drivability by changing engine characteristics according to a current position of a vehicle. An aspect of the present disclosure further contributes to improvement of energy efficiency of a vehicle.

### BRIEF DESCRIPTION OF DRAWINGS

Exemplary embodiment(s) of the present invention will be described in detail based on the following figures, wherein:

FIG. 1 is a block diagram schematically illustrating a configuration example of a vehicle V including a control device 20 according to the present embodiment;

FIG. 2 is a diagram illustrating a first example of a specific control performed by the control device 20;

FIG. 3 is a diagram illustrating a second example of the specific control performed by the control device 20;

FIG. 4 is a diagram illustrating a third example of the specific control performed by the control device 20;

FIG. 5 is a diagram illustrating a fourth example of the specific control performed by the control device 20;

FIG. 6 is a diagram illustrating a fifth example of the specific control performed by the control device 20.

### DESCRIPTION OF EMBODIMENTS

Hereinafter, an embodiment of a control device according to the present disclosure will be described in detail with reference to the drawings. The drawings are viewed in directions of reference numerals. Not all the elements to be described in the following embodiments are necessarily essential for the present disclosure. In the following description, the same or similar elements are denoted by the same or similar reference numerals, and a description thereof may be omitted or simplified as appropriate.

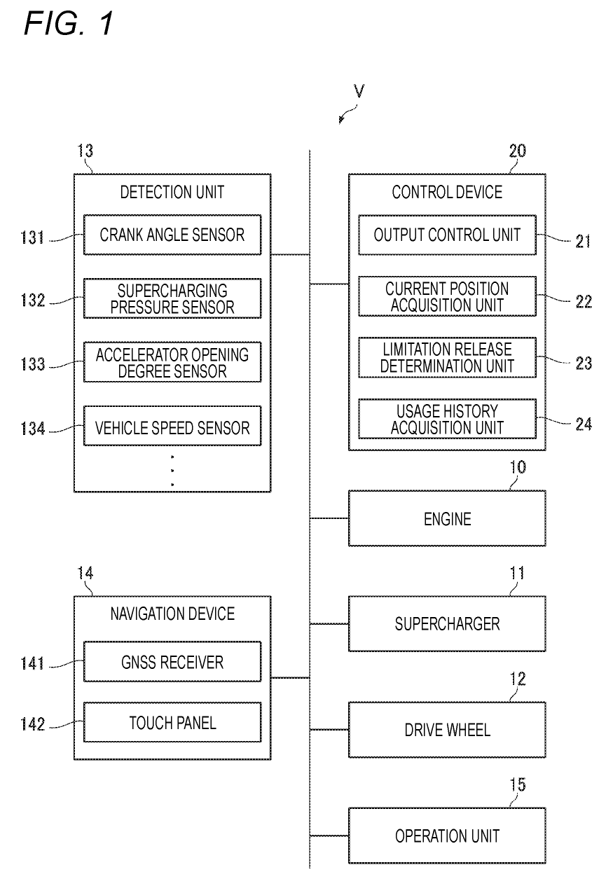

First, a vehicle V including a control device 20, which is an embodiment of the present disclosure, will be described with reference to FIG. 1. As illustrated in FIG. 1, the vehicle V includes an engine 10 serving as a driving force source of the vehicle V and the control device 20 that controls the entire vehicle V including the engine 10.

The engine 10 is an internal combustion engine that outputs mechanical energy (in other words, power) generated by burning a mixture of supplied fuel and air. The power output from the engine 10 is transmitted to a drive wheel 12 of the vehicle V via a transmission (not illustrated) or the like. Accordingly, a driving force for the vehicle V to travel is generated.

The vehicle V further includes a supercharger 11 that supercharges intake air of the engine 10. The supercharger 11 may be an exhaust turbine type turbocharger, a mechanical type supercharger (a mechanical supercharger), or an electric turbocharger driven by an electric motor. That is, the type of the supercharger 11 is not particularly limited as long as the supercharger 11 can supercharge the intake air of the engine 10.

As an example, in the following description, it is assumed that the supercharger 11 is an exhaust turbine type turbocharger. In this case, the supercharger 11 includes a waste gate valve (not illustrated) capable of controlling a supercharging pressure of the supercharger 11 using an electric actuator or the like. The waste gate valve is controlled by, for example, the control device 20 to be described later. In other words, the control device 20 can control the supercharging pressure of the supercharger 11 via the waste gate valve.

The vehicle V further includes a detection unit 13, a navigation device 14, and an operation unit 15. The detection unit 13 includes various sensors for acquiring information necessary for the control device 20 to control the vehicle V, and outputs detection signals indicating detection values of the various sensors to the control device 20.

For example, the detection unit 13 includes a crank angle sensor 131 that detects a crank angle of the engine 10, a supercharging pressure sensor 132 that detects the supercharging pressure of the supercharger 11, an accelerator opening degree sensor 133 that detects an accelerator opening degree that is an operation amount of an accelerator pedal of the vehicle V, and a vehicle speed sensor 134 that detects a vehicle speed that is a travel speed of the vehicle V. In this case, the control device 20 can acquire information indicating an engine rotation speed (that is, the rotation speed of the engine 10), which is the number of revolutions per unit time of the engine 10, based on the detection signal from the crank angle sensor 131. Further, the control device 20 can acquire information indicating the supercharging pressure of the supercharger 11 based on the detection signal from the supercharging pressure sensor 132. The control device 20 can acquire information indicating the accelerator opening degree based on the detection signal from the accelerator opening degree sensor 133. The control device 20 can acquire information indicating the vehicle speed based on the detection signal from the vehicle speed sensor 134.

The navigation device 14 includes, for example, a global navigation satellite system (GNSS) receiver 141, and a touch panel 142.

The GNSS receiver 141 specifies a current position of the vehicle V (for example, a latitude and a longitude of a location where the vehicle V is located) based on a signal received from a GNSS satellite. The navigation device 14 may specify or complement the current position of the vehicle V by, for example, an inertial navigation system (INS) using detection values of sensors provided in the vehicle V. The navigation device 14 outputs position information indicating the current position of the vehicle V specified by the GNSS receiver 141 or the like to the control device 20. Accordingly, the control device 20 can acquire the position information indicating the current position of the vehicle V.

For example, the touch panel 142 is implemented by combining a display device such as a liquid crystal display or an organic light emitting diode (OLED) with a pointing device (for example, a touch pad).

The navigation device 14 includes a storage unit (not illustrated) implemented by a flash memory or the like. The storage unit stores a map information database and the like. The map information database includes road network information. The road network information is information representing roads based on a combination of nodes and links connecting the nodes (also referred to as "paths"). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a traveling direction, a road type, and the like is set.

For example, the navigation device 14 searches for, by referring to the map information database, a route from the current position of the vehicle V to a destination set by a user using the touch panel 142. Then, the navigation device 14 performs route guidance using the touch panel 142 based on the found route. Further, the navigation device 14 may cause the touch panel 142 to perform a predetermined display according to an instruction from the control device 20. Further, the navigation device 14 may output predetermined information (for example, information indicating an operation received via the touch panel 142) to the control device 20.

The control device 20 controls the overall operation of the vehicle V based on information acquired via the detection unit 13, the navigation device 14, and the like. In the present embodiment, the control device 20 can perform, for example, a control for determining whether the current position of the vehicle V is within a predetermined area, a control for determining a driving state of the vehicle V such as the current engine rotation speed, the supercharging pressure, or the accelerator opening degree, and a control for adjusting the output of the engine 10.

More specifically, the control device 20 includes, for example, an output control unit 21, a current position acquisition unit 22, and a limitation release determination unit 23 as functional units realized by a processor of an electronic control unit (ECU) realizing the control device 20 executing a program stored in a memory or an interface of the ECU.

The output control unit 21 controls the output of the engine 10. For example, the output control unit 21 can control the output of the engine 10 by controlling the supercharging pressure of the supercharger 11 or a fuel injection amount to the engine 10 by a fuel supply device (not illustrated).

In the present embodiment, the control device 20 can change characteristics of the engine 10 (hereinafter also referred to as "engine characteristics") according to the current position of the vehicle V. Therefore, the output control unit 21 can change the engine characteristics according to the current position of the vehicle V acquired by the current position acquisition unit 22 to be described later. Here, the engine characteristics may be an output characteristic of the engine 10 or a torque characteristic of the engine 10.

For example, the control device 20 can operate in a normal mode and a high output mode both of which are related to the engine characteristics. Here, the engine characteristics are set to normal output characteristics or normal torque characteristics in the normal mode. On the other hand, the engine characteristics in the high output mode can be set a higher output or higher torque than in the normal mode. For example, the control device 20 switches the normal mode and the high output mode according to the current position of the vehicle V acquired by the current position acquisition unit 22.

As an example, the control device 20 is set to the normal mode when the current position of the vehicle V is on a general road or a public road. On the other hand, the control device 20 is set to the high output mode when the current position of the vehicle V is within an automobile competition course or private land. The automobile competition course in this case is a course or an area divided from a general road or a public road corresponds to a predetermined area in the present embodiment. For example, an automobile racing circuit, a rally course set or regulated for a rally competition, or a gymkhana competition venue are the automobile competition course. A private land to which the Road Traffic Law is not applied is also an area divided from a general road or a public road, and corresponds to the predetermined area in the present embodiment.

For example, the output control unit 21 can limit the maximum output of the engine 10 to a predetermined limit value (for example, an output Pmax1 to be described later). When the normal mode is set because the vehicle V is located outside the predetermined area, the output control unit 21 limits the maximum output of the engine 10 to the predetermined limit value. In other words, in this case, the output control unit 21 does not release the limitation which limits the maximum output of the engine 10 to the predetermined limit value.

On the other hand, when the high output mode is set because the vehicle V is located within the predetermined area, the output control unit 21 increases the maximum output of the engine 10 to be larger than the predetermined limit value (for example, an output Pmax2 to be described later). In other words, in this case, the output control unit 21 releases the limitation which limits the maximum output of the engine 10 to the predetermined limit value.

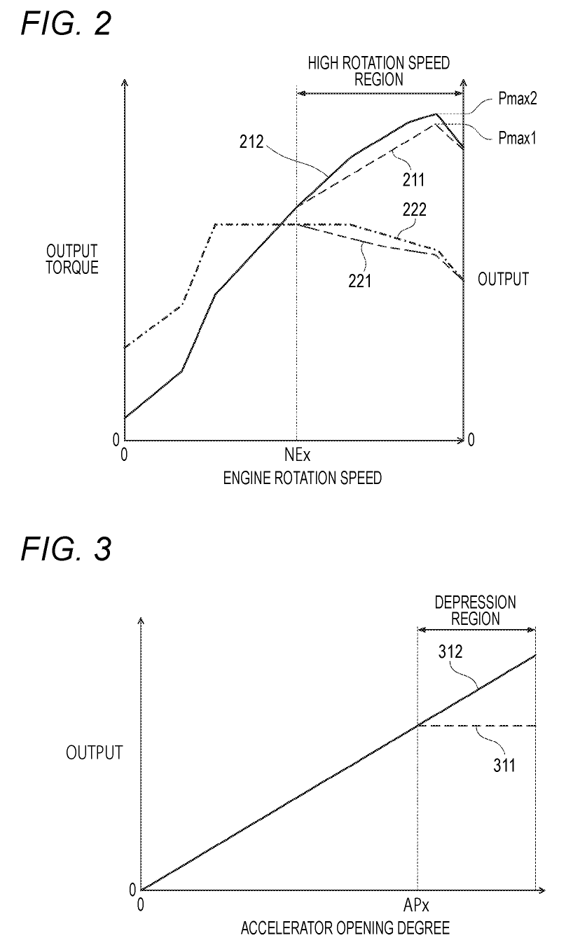

When the limitation is released, the output control unit 21 may increase the output or the output torque of the engine 10 in a high rotation speed region in which the rotation speed of the engine 10 (that is, the engine rotation speed) is higher than a predetermined value compared to when the limitation is applied. An example of increasing the output or the output torque of the engine 10 in the high rotation speed region, compared to when the limitation is applied, will be described later with reference to FIG. 2 and the like.

When the limitation is released, the output control unit 21 may increase the output of the engine 10 in a depression region in which the accelerator opening degree of the vehicle V is larger than a predetermined value compared to when the limitation is applied. An example of increasing the output of the engine 10 in the depression region, compared to when the limitation is applied, will be described later with reference to FIG. 3 and the like.

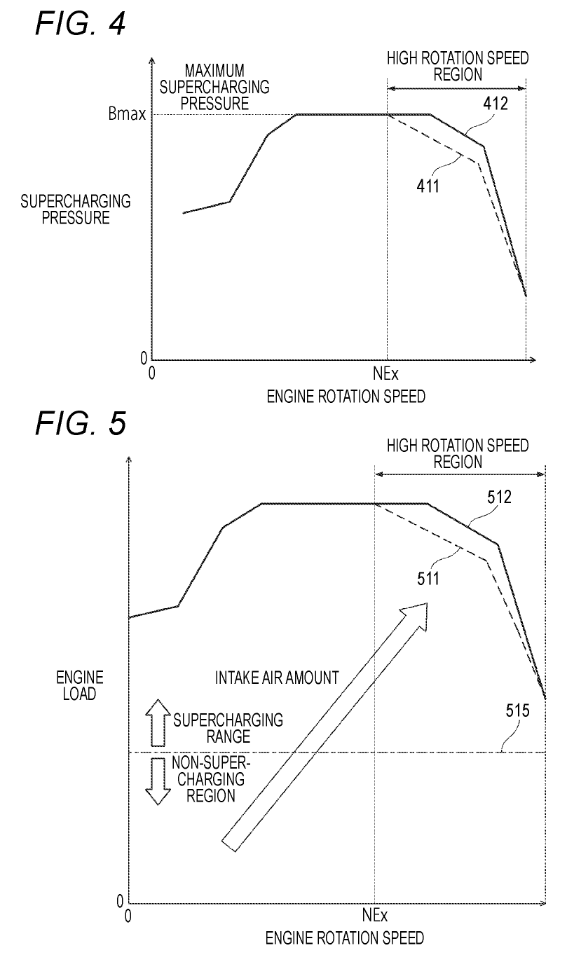

When the limitation is released, the output control unit 21 may increase the supercharging pressure of the supercharger 11 in the high rotation speed region, compared to when the limitation is applied. Further, when the limitation is released, the output control unit 21 may increase the supercharging pressure of the supercharger 11 in the high rotation speed region within a range in which the supercharging pressure is equal to or lower than a predetermined maximum supercharging pressure, compared to when the limitation is applied. An example of increasing the supercharging pressure in the high rotation speed region, compared to when the limitation is applied, will be described later with reference to FIG. 4 and the like.

When the limitation is released, the output control unit 21 may set a target air-fuel ratio, which is the target value of the fuel and the air supplied to the engine 10, to a second air-fuel ratio. At the second air-fuel ratio, a fuel injection amount of the engine 10 is larger than a first air-fuel ratio, which is a target air-fuel ratio when the limitation is applied. An example of increasing the fuel injection amount, compared to when the limitation is applied, will be described later with reference to FIG. 5 and the like.

The current position acquisition unit 22 acquires information indicating the current position of the vehicle V. For example, the current position acquisition unit 22 acquires the information indicating the current position of the vehicle V based on the position information from the navigation device 14.

The limitation release determination unit 23 determines whether the limitation by the output control unit 21 can be released based on the information indicating the current position of the vehicle V acquired by the current position acquisition unit 22. For example, when the limitation release determination unit 23 determines that the current position of the vehicle V is within the predetermined area, the limitation release determination 23 determines that the limitation by the output control unit 21 can be released. When the limitation release determination unit 23 determines that the limitation can be released, the control device 20 is set in the high output mode.

On the other hand, when the limitation release determination unit 23 determines that the current position of the vehicle V is outside the predetermined area, the limitation release determination unit 23 determines that the limitation by the output control unit 21 cannot be released. When the limitation release determination unit 23 determines that the limitation cannot be released, the control device 20 does not switch to the high output mode but remain in the normal mode.

The limitation release determination unit 23 may determine that the limitation by the output control unit 21 can be released when it is determined that the current position of the vehicle V is within the predetermined area and a predetermined operation is performed by the user (for example, a driver) of the vehicle V. In other words, the limitation release determination unit 23 may determine that the limitation by the output control unit 21 cannot be released when there is no predetermined operation from the user of the vehicle V even if the current position of the vehicle V is within the predetermined area.

Even when the current position of the vehicle V is within the predetermined area, the limitation release determination unit 23 may determine that the limitation by the output control unit 21 cannot be released when the number of times the limitation by the limitation release determination unit 23 is released or the number of times the engine 10 reaches the high rotation speed region in a state where the limitation by the limitation release determination unit 23 is released exceeds a threshold value.

In this case, the control device 20 further includes a usage history acquisition unit 24 as a functional unit realized by, for example, a processor of an ECU realizing the control device 20 executing a program stored in a memory or an interface of the ECU. Here, the usage history acquisition unit 24 counts the number of times the limitation by the limitation release determination unit 23 is released or the number of times the engine 10 reaches the high rotation speed region in the state where the limitation by the limitation release determination unit 23 is released. Even when the current position of the vehicle V is within the predetermined area, the limitation release determination unit 23 may determine that the limitation by the output control unit 21 cannot be released when the number of times counted by the usage history acquisition unit 24 exceeds the threshold value. In this case, the threshold value can be appropriately determined by the manufacturer of the vehicle V.

### Examples of Specific Controls Performed by Control Device

FIG. 2 is a diagram illustrating a first example of a specific control performed by the control device 20. In FIG. 2, a right vertical axis represents the output of the engine 10, a left vertical axis represents the output torque of the engine 10, and a horizontal axis represents the engine rotation speed (that is, the rotation speed of the engine 10), which is the number of revolutions per unit time of the engine 10.

In FIG. 2, a broken line 211 indicates the output characteristic of the engine 10 in the normal mode, and a solid line 212 indicates the output characteristic of the engine 10 in the high output mode. As indicated by the broken line 211, the maximum output of the engine 10 in the normal mode is set to an output Pmax1. On the other hand, as indicated by the solid line 212, the maximum output of the engine 10 in the high output mode is set to an output Pmax2 larger than the output Pmax1. That is, in the normal mode, the maximum output of the engine 10 is limited to the output Pmax1, whereas in the high output mode, the limitation on the maximum output of the engine 10 is released, and the maximum output of the engine 10 becomes the output Pmax2 larger than the output Pmax1.

As illustrated in FIG. 2, the control device 20 may make the output characteristic of the engine 10 in the high rotation speed region in which the engine rotation speed is higher than a predetermined value NEx different between the normal mode and the high output mode. In this case, the control device 20 may set the output characteristic of the engine 10 to be the same as that in the normal mode even in the high output mode in a low rotation speed region in which the engine rotation speed is equal to or lower than the predetermined value NEx.

In the example illustrated in FIG. 2, the output of the engine 10 in the high rotation speed region in the high output mode is generally larger than the output of the engine 10 in the high rotation speed region in the normal mode. As described above, the control device 20 (for example, the output control unit 21) may increase the output of the engine 10 in the high rotation speed region in the case of the high output mode (that is, when the limitation is released) as compared with that in the normal mode (that is, when the limitation is applied).

In FIG. 2, a two-dot chain line 221 indicates the torque characteristic of the engine 10 in the normal mode, and a one-dot chain line 222 indicates the torque characteristic of the engine 10 in the high output mode. As indicated by the two-dot chain line 221 and the one-dot chain line 222, the control device 20 may make the torque characteristic of the engine 10 in the high rotation speed region different between the normal mode and the high output mode. In this case, in the low rotation speed region, the control device 20 may set the torque characteristic of the engine 10 to be the same as that in the normal mode even in the high output mode.

In the example illustrated in FIG. 2, the output torque of the engine 10 in the high rotation speed region in the high output mode is generally larger than the output torque of the engine 10 in the high rotation speed region in the normal mode. As described above, the control device 20 (for example, the output control unit 21) may increase the output torque of the engine 10 in the high rotation speed region in the case of the high output mode (that is, when the limitation is released) as compared with that in the normal mode (that is, when the limitation is applied).

FIG. 3 is a diagram illustrating a second example of the specific control performed by the control device 20. In FIG. 3, a vertical axis represents the output of the engine 10, and a horizontal axis represents the accelerator opening degree. In FIG. 3, a broken line 311 indicates the output characteristic of the engine 10 with respect to the accelerator opening degree in the normal mode. In FIG. 3, a solid line 312 indicates the output characteristic of the engine 10 with respect to the accelerator opening degree in the high output mode.

As indicated by the broken line 311 and the solid line 312, the control device 20 may make the output characteristic of the engine 10 in the depression region in which the accelerator opening degree is larger than a predetermined value APx different between the normal mode and the high output mode. In this case, in a non-depression region in which the accelerator opening degree is equal to or less than the predetermined value APx, the control device 20 may set the output characteristic of the engine 10 to be the same as that in the normal mode even in the high output mode.

In the example illustrated in FIG. 3, the output of the engine 10 in the non-depression region is the same in both the normal mode and the high output mode. On the other hand, the output of the engine 10 in the depression region is larger in the high output mode than in the normal mode. As described above, the control device 20 may increase the output of the engine 10 in the depression region in the case of the high output mode (that is, when the limitation is released) as compared with that in the normal mode (that is, when the limitation is applied). Instead of or in addition to this, the control device 20 may increase the output torque of the engine 10 in the depression region in the case of the high output mode (that is, when the limitation is released) as compared with that in the normal mode (that is, when the limitation is applied).

FIG. 4 is a diagram illustrating a third example of the specific control performed by the control device 20. In FIG. 4, a vertical axis represents the supercharging pressure of the engine 10 by the supercharger 11, and a horizontal axis represents the engine rotation speed (that is, the rotation speed of the engine 10).

In FIG. 4, a broken line 411 indicates a relationship between the engine rotation speed and the supercharging pressure in the normal mode, that is, a supercharging pressure characteristic for the engine 10. In FIG. 4, a solid line 412 indicates the supercharging pressure characteristic for the engine 10 in the high output mode.

As indicated by the broken line 411 and the solid line 412, the control device 20 may make the supercharging pressure characteristic in the high rotation speed region in which the engine rotation speed is higher than the predetermined value NEx different between the normal mode and the high output mode. In this case, the control device 20 may set the supercharging pressure characteristic to be the same as that in the normal mode even in the high output mode in the low rotation speed region in which the engine rotation speed is equal to or lower than the predetermined value NEx.

In the example illustrated in FIG. 4, the maximum supercharging pressure Bmax can be obtained from the low rotation speed region in both the normal mode and the high output mode. Then, in the case of the normal mode, when the engine rotation speed enters the high rotation speed region, the supercharging pressure is immediately reduced from the maximum supercharging pressure Bmax, whereas in the case of the high output mode, the supercharging pressure can be maintained at the maximum supercharging pressure Bmax until the engine rotation speed becomes high to some extent even after the engine rotation speed enters the high rotation speed region.

As described above, the control device 20 may increase the supercharging pressure of the supercharger 11 in the high rotation speed region in the case of the high output mode (that is, when the limitation is released) as compared with that in the normal mode (that is, when the limitation is applied). However, from the viewpoint of ensuring the durability of the supercharger 11, even in the high output mode, the control device 20 preferably sets the supercharging pressure in the high rotation speed region to be higher than that in the normal mode within the range in which the supercharging pressure is equal to or lower than the predetermined maximum supercharging pressure Bmax.

FIG. 5 is a diagram illustrating a fourth example of the specific control performed by the control device 20. In FIG. 5, a vertical axis represents a load on the engine 10 (an engine load). The fuel injection amount and the intake air amount increase toward the upper right in FIG. 5. In FIG. 5, a horizontal axis represents the engine rotation speed (that is, the rotation speed of the engine 10).

In FIG. 5, a broken line 511 indicates a target air-fuel ratio corresponding to a combination of the engine rotation speed and the engine load in the normal mode, which is an example of the first air-fuel ratio. In FIG. 5, a solid line 512 indicates a target air-fuel ratio corresponding to a combination of the engine rotation speed and the engine load in the high output mode, which is an example of the second air-fuel ratio. In FIG. 5, a one-dot chain line 515 indicates a boundary of the engine load between a supercharging region in which supercharging by the supercharger 11 is performed (in other words, the supercharging pressure > 0) and a non-supercharging region in which the supercharging by the supercharger 11 is not performed (in other words, the supercharging pressure = 0).

As indicated by the broken line 511 and the solid line 512, the control device 20 may make the target air-fuel ratio (in other words, at least one of the intake air amount and the fuel injection amount) in the high rotation speed region in which the engine rotation speed is higher than the predetermined value NEx different between the normal mode and the high output mode. In this case, the control device 20 may set the target air-fuel ratio to be the same as that in the normal mode even in the high output mode in the low rotation speed region in which the engine rotation speed is equal to or lower than the predetermined value NEx.

In the example illustrated in FIG. 5, the target air-fuel ratio in the low rotation speed region is the same in both the normal mode and the high output mode. On the other hand, the target air-fuel ratio in the high rotation speed region is different between the normal mode and the high output mode. Specifically, the target air-fuel ratio in the high rotation speed region is a target air-fuel ratio at which the intake air amount and the fuel injection amount are larger than those in the normal mode.

In this way, in the case of the high output mode (that is, when the limitation is released), the control device 20 (for example, the output control unit 21) may set the target air-fuel ratio to the second air-fuel ratio at which the intake air amount and the fuel injection amount are larger than the first air-fuel ratio, which is the target air-fuel ratio when the limitation is applied. Here, in the case of the high output mode (that is, when the limitation is released), the intake air amount and the fuel injection amount are made larger compared to when the limitation is applied, but the present invention is not limited thereto. For example, the control device 20 (for example, the output control unit 21) may set only one of the intake air amount and the fuel injection amount to be larger in the case of the high output mode compared to when the limitation is applied. In other words, only one of the intake air amount and the fuel injection amount of the second air-fuel ratio may be larger than that of the first air-fuel ratio.

In general, by increasing the fuel ratio, a high output is easily obtained as the output of the engine 10. Therefore, by setting the target air-fuel ratio to the second air-fuel ratio, which is the target air-fuel ratio in the high output mode, to be larger in the fuel injection amount (in other words, higher in the fuel ratio) than the first air-fuel ratio, which is the target air-fuel ratio when the limitation is applied, it becomes easier to obtain a higher output as the output of the engine 10 in the high output mode compared to when the limitation is applied (that is, in the normal mode). However, the present invention is not limited thereto. For example, if a higher output is obtained by making the fuel ratio lower than the first air-fuel ratio, the second air-fuel ratio may be one in which the fuel ratio is lower than the first air-fuel ratio (that is, the fuel injection amount is reduced). In this way, in the case of the high output mode (that is, when the limitation is released), the control device 20 (for example, the output control unit 21) may set the target air-fuel ratio to the second air-fuel ratio at which at least one of the intake air amount and the fuel injection amount is larger than the first air-fuel ratio, which is the target air-fuel ratio when the limitation is applied.

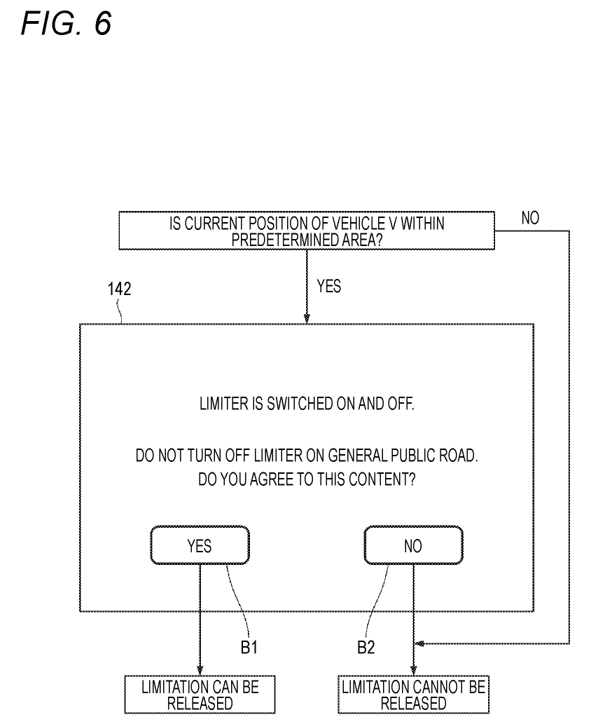

FIG. 6 is a diagram illustrating a fifth example of the specific control performed by the control device 20. The limitation release determination unit 23 of the control device 20 may determine to release the limitation by the output control unit 21, for example, when a predetermined operation of the user is received by the touch panel 142 of the navigation device 14.

In this case, as illustrated in FIG. 6, when the control device 20 determines that the current position of the vehicle V is within the predetermined area, a limitation release button B1 and a limitation release prohibition button B2 are displayed on the touch panel 142 of the navigation device 14 together with a predetermined message. In the example illustrated in FIG. 6, a predetermined message is displayed, such as "limiter can be switched on and off. Do not turn off limiter on general public road. Do you agree to the above?" By displaying such a display screen on the touch panel 142, the user of the vehicle V can read the message and perform an operation of selectively tapping the limitation release button B1 or the limitation release prohibition button B2 by his/her own intention.

When the operation of selecting the limitation release button B1 (for example, an operation of tapping the limitation release button B1) is performed, the control device 20 (for example, the limitation release determination unit 23) determines that the limitation by the output control unit 21 can be released. On the other hand, even the current position of the vehicle V is determined to be within the predetermined area, if there is no operation of selecting the limitation release button B1, the control device 20 determines that the limitation by the output control unit 21 cannot be released. When the current position of the vehicle V is determined to be outside the predetermined area, the control device 20 determines that the limitation by the output control unit 21 cannot be released without displaying the display screen including the limitation release button B1 and the like.

### Effects of Present Embodiment

As described above, the control device 20 includes the output control unit 21 configured to limit the maximum output of the engine 10 to the predetermined limit value, the current position acquisition unit 22 configured to acquire the information indicating the current position of the vehicle V, and the limitation release determination unit 23 configured to determine whether the limitation by the output control unit 21 can be released based on the information indicating the current position of the vehicle V acquired by the current position acquisition unit 22. The limitation release determination unit 23 determines that the limitation by the output control unit 21 can be released when the current position of the vehicle V is determined to be within the predetermined area, and determines that the limitation by the output control unit 21 cannot be released when the current position of the vehicle V is determined to be outside the predetermined area. In addition, the output control unit 21 releases the limitation based on the limitation release determination unit 23 determining that the limitation can be released, and increase the maximum output of the engine 10 larger than the limitation value.

By providing the control device 20 with the above configuration, when the vehicle V is located within the predetermined area such as the circuit or the private land, the limitation on the maximum output of the engine 10 can be released. Therefore, the engine characteristics of the vehicle V can be changed between the case where the vehicle V is located within the predetermined area and the case where the vehicle V is located outside the predetermined area. Therefore, within the predetermined area, the vehicle V can travel with the engine characteristics for the predetermined area different from that outside the predetermined area, and it is possible to make the user feel the traveling with the engine characteristics. In addition, as the maximum output increases, the maximum speed increases, which can be felt by the user. That is, drivability is improved. In addition, since the limitation is not released outside the predetermined area, the safety of the vehicle V outside the predetermined area can be improved, and the durability of the engine 10 can be ensured by reducing excessive usage of the engine 10. Therefore, it is possible to contribute to the improvement of the energy efficiency of the vehicle V.

When the limitation is released, the output control unit 21 may increase the output of the engine 10 in the high rotation speed region, compared to when the limitation is applied. In this way, when the limitation on the maximum output of the engine 10 is released, the output of the engine 10 in the high rotation speed region can also be increased, compared to when the limitation is applied. As a result, when the vehicle V travels with the engine characteristics for the predetermined area, an acceleration performance of the vehicle V in the high rotation speed region can be increased, and even before the output of the engine 10 reaches the maximum output, it is possible to make the user to feel the traveling with the engine characteristics. That is, drivability is improved.

When the limitation is released, the output control unit 21 may increase the output torque of the engine 10 in the high rotation speed region, compared to when the limitation is applied. In this way, when the limitation on the maximum output of the engine 10 is released, the output torque of the engine 10 in the high rotation speed region can also be increased, compared to when the limitation is applied. As a result, when the vehicle V travels with the engine characteristics for the predetermined area, an acceleration performance of the vehicle V in the high rotation speed region can be improved, and even before the output of the engine 10 reaches the maximum output, it is possible to make the user to feel the traveling with the engine characteristics. That is, drivability is improved.

When the limitation is released, the output control unit 21 may increase the output of the engine 10 in the depression region, compared to when the limitation is applied. In this way, when the limitation on the maximum output of the engine 10 is released, the output of the engine 10 in the depression region, in which the accelerator opening degree is relatively large, can also be increased, compared to when the limitation is applied. As a result, when the vehicle V travels with the engine characteristics for the predetermined area, the acceleration performance of the vehicle V in the depression region can be increased, and even before the output of the engine 10 reaches the maximum output, it is possible to make the user to feel the traveling with the engine characteristics. That is, the drivability is improved.

When the limitation is released, the output control unit 21 may increase the supercharging pressure of the supercharger 11 in the high rotation speed region, compared to when the limitation is applied. In this way, the output and the output torque of the engine 10 in the high rotation speed region can be easily increased, and the acceleration performance and the maximum speed can be improved, which can be felt by the user. That is, the drivability is improved.

When the limitation is released, the output control unit 21 may increase the supercharging pressure of the supercharger 11 in the high rotation speed region within the range in which the supercharging pressure is equal to or lower than the predetermined maximum supercharging pressure Bmax, compared to when the limitation is applied. In this way, even when the limitation on the maximum output of the engine is released, that is, even when the supercharging pressure of the supercharger 11 can be made higher than usual, the durability of the supercharger 11 can be ensured by keeping the supercharging pressure within the range in which the supercharging pressure is equal to or lower than the predetermined maximum supercharging pressure.

When the limitation is released, the output control unit 21 may set the target air-fuel ratio to the second air-fuel ratio at which at least one of the intake air amount and the fuel injection amount is larger than the first air-fuel ratio, which is the target air-fuel ratio when the limitation is applied. Thus, when the limitation is released, the output and the output torque of the engine 10 can be easily increased. For example, when the limitation is released, the output control unit 21 may set the target air-fuel ratio to the second air-fuel ratio at which the fuel injection amount is larger than the first air-fuel ratio, which is the target air-fuel ratio when the limitation is applied. In this way, when the limitation on the maximum output of the engine 10 is released, the output and the output torque of the engine 10 can be easily increased by setting the target air-fuel ratio to the second air-fuel ratio at which the fuel injection amount is larger than the first air-fuel ratio, which is the target air-fuel ratio when the limitation is applied. Further, when the limitation is applied, by setting the target air-fuel ratio to the first air-fuel ratio at which the fuel injection amount is relatively small, a fuel consumption amount of the vehicle V can be reduced to improve a fuel consumption performance.

The limitation release determination unit 23 may determine that the limitation by the output control unit 21 can be released when the current position of the vehicle V is determined to be within the predetermined area and a predetermined operation is performed by the user of the vehicle V. In this way, since the limitation on the maximum output of the engine 10 can be released on condition that the predetermined operation is performed by the user of the vehicle V, it is possible to prevent the limitation from being released against the intention of the user. In addition, in this way, since the limitation can be released after the vehicle V is located within the predetermined area such as a circuit and the user's confirmation is obtained, it is possible to consider the safety of the vehicle V and to reduce the frequency of releasing the limitation to ensure the durability of the engine 10.

The control device 20 may include the usage history acquisition unit 24 capable of counting the number of times the limitation by the output control unit 21 is released or the number of times the engine 10 reaches the high rotation speed region in the state where the limitation by the output control unit 21 is released. In this case, the limitation release determination unit 23 may determine that the limitation cannot be released when the current position of the vehicle V is determined to be within the predetermined area and the number of times counted by the usage history acquisition unit 24 exceeds the threshold value. In this way, after the number of times the limitation on the maximum output of the engine 10 is released or the number of times the engine 10 reaches the high rotation speed region in the state where the limitation on the maximum output of the engine 10 is released exceeds the threshold value, the limitation on the maximum output of the engine can be prevented from being released. Therefore, after the number of times the limitation on the maximum output of the engine 10 is released or the number of times the engine 10 reaches the high rotation speed region in the state where the limitation on the maximum output of the engine 10 is released exceeds the threshold value, it is possible to prevent the engine 10 from being excessively used and ensure the durability of the engine 10.

The embodiment of the present invention has been described above, but the present invention is not limited to the embodiment described above, and modifications, improvements, and the like can be made as appropriate.

For example, in the above embodiment, an example of a configuration in which the engine 10 is provided as a driving force source of the vehicle V is illustrated, but the vehicle V to be controlled by the control device 20 in the present disclosure may be, for example, a hybrid vehicle using the engine 10 and an electric motor as driving force sources.

In the present description and the like, at least the following matters are described. Although corresponding constituent elements or the like in the embodiment described above are shown in parentheses, the present invention is not limited thereto.

(1) A control device (control device 20) that controls a vehicle capable of traveling by driving a drive wheel (drive wheel 12) with an output of an engine (engine 10), the control device including:

a processor (output control unit 21, current position acquisition unit 22, and limitation release determination unit 23) configured to

limit a maximum output of the engine to a predetermined limit value,

acquire information indicating a current position of the vehicle, and

determine whether the processor can release limitation on the maximum output based on the information indicating the current position acquired by the processor, in which

the processor determines that the limitation can be released when the current position is determined to be within a predetermined area, and determines that the limitation cannot be released when the current position is determined to be outside the predetermined area, and

when the processor determines that the limitation can be released, the processor releases the limitation and increases the maximum output to a value larger than the limit value.

According to (1), when the vehicle is located within a predetermined area such as a circuit or private land, the limitation on the maximum output of the engine can be released. Thus, the engine characteristics of the vehicle can be changed between the case where the vehicle is located within the predetermined area and the case where the vehicle is located outside the predetermined area. Then, within the predetermined area, the vehicle can travel with the engine characteristics for the predetermined area different from that outside the predetermined area, and it is possible to make the user to feel the traveling with the engine characteristics. That is, drivability is improved. In addition, since the limitation is not released outside the predetermined area, safety of the vehicle outside the predetermined area can be improved, and the durability of the engine can be ensured by reducing excessive usage of the engine. In addition, it is possible to improve traffic safety and contribute to development of a sustainable transportation system.

(2) The control device according to (1), in which

when the limitation is released, the processor increases the output of the engine to a value in a high rotation speed region where a rotation speed of the engine is higher than a predetermined value, the value being larger than the output during the limitation.

According to (2), when the limitation on the maximum output of the engine is released, the output of the engine in the high rotation speed region can also be increased, compared to when the limitation is applied. As a result, when the vehicle travels with the engine characteristics for the predetermined area, the travel speed of the vehicle in the high rotation speed region can be increased, and even before the output of the engine reaches the maximum output, it is possible to make the user to feel the traveling with the engine characteristics for the predetermined area.

(3) The control device according to (1), in which

when the limitation is released, the processor increases an output torque of the engine to a value in a high rotation speed region where a rotation speed of the engine is higher than a predetermined value, the value being larger than the output torque during the limitation.

According to (3), when the limitation on the maximum output of the engine is released, the output torque of the engine in the high rotation speed region can also be increased, compared to when the limitation is applied. As a result, when the vehicle travels with the engine characteristics for the predetermined area, an acceleration performance of the vehicle in the high rotation speed region can be improved, and even before the output of the engine reaches the maximum output, it is possible to make the user to feel the traveling with the engine characteristics for the predetermined area.

(4) The control device according to any one of (1) to (3), in which

when the limitation is released, the processor increases the output of the engine to a value in a depression region where an accelerator opening degree of the vehicle is larger than a predetermined value, the value being larger than the output during the limitation.

According to (4), when the limitation on the maximum output of the engine is released, the output of the engine in the depression region in which the accelerator opening degree is relatively large can also be increased, compared to when the limitation is applied. As a result, when the vehicle travels with the engine characteristics for the predetermined area, the travel speed of the vehicle in the depression region can be increased, and even before the output of the engine reaches the maximum output, it is possible to make the user to feel the traveling with the engine characteristics for the predetermined area.

(5) The control device according to any one of (1) to (3), in which

the vehicle further includes a supercharger (supercharger 11) that supercharges intake air of the engine, and

when the limitation is released, the processor increases a supercharging pressure by the supercharger to a value in a high rotation speed region where a rotation speed of the engine is higher than a predetermined value, the value being larger than the supercharging pressure during the limitation.

According to (5), when the limitation on the maximum output of the engine is released, the supercharging pressure by the supercharger in the high rotation speed region is increased, compared to when the limitation is applied, so that the output and the output torque of the engine in the high rotation speed region can be easily increased.

(6) The control device according to (5), in which

when the limitation is released, the processor increases the supercharging pressure to the value in the high rotation speed region, the value being larger than the supercharging pressure during the limitation, and within a range where the supercharging pressure is equal to or lower than a predetermined maximum supercharging pressure (maximum supercharging pressure Bmax).

According to (6), even when the limitation on the maximum output of the engine is released, that is, even when the supercharging pressure by the supercharger can be made higher than usual, the durability of the supercharger can be ensured by keeping the supercharging pressure within the range in which the supercharging pressure is equal to or lower than the predetermined maximum supercharging pressure.

(7) The control device according to any one of (1) to (3), in which

when the limitation is released, the processor performs a control based on a second air-fuel ratio, the second air-fuel ration being an air-fuel ratio at which at least one of an intake air amount and a fuel injection amount is larger than a first air-fuel ratio that is the target air-fuel ratio during the limitation.

According to (7), when the limitation on the maximum output of the engine is released, the output and the output torque of the engine can be easily increased by setting the target air-fuel ratio to the second air-fuel ratio at which at least one of the intake air amount and the fuel injection amount is larger than the first air-fuel ratio, which is the target air-fuel ratio when the limitation is applied.

(8) The control device according to any one of (1) to (3), in which

the processor determines that the limitation can be released when the current position is determined to be within the predetermined area and a predetermined operation performed by a user of the vehicle is received.

According to (8), it is possible to prevent the limitation from being released against the intention of the user by releasing the limitation on the maximum output of the engine on the condition that the predetermined operation is performed by the user of the vehicle.

(9) The control device according to any one of (1) to (3),

in which the processor (usage history acquisition unit 24) is configured to count the number of times the limitation is released or the number of times the engine reaches a high rotation speed region where a rotation speed of the engine is larger than a predetermined value in a state where the limitation is released, and

in which the processor determines that the limitation cannot be released when the current position is determined to be within the predetermined area and the number of times counted by the processor exceeds a threshold value.

According to (9), after the number of times the limitation on the maximum output of the engine is released or the number of times the engine reaches the high rotation speed region in a state where the limitation on the maximum output of the engine is released exceeds the threshold value, the limitation on the maximum output of the engine is not released, so that it is possible to prevent the engine from being excessively used and ensure the durability of the engine.

What is claimed is:

1. A control device that controls a vehicle capable of traveling by driving a drive wheel with an output of an engine, the control device comprising:
a processor configured to
limit a maximum output of the engine to a predetermined limit value,
acquire information indicating a current position of the vehicle, and
determine whether the processor can release limitation on the maximum output based on the information indicating the current position acquired by the processor, wherein
the processor determines that the limitation can be released when the current position is determined to be within a predetermined area, and determines that the limitation cannot be released when the current position is determined to be outside the predetermined area, and
when the processor determines that the limitation can be released, the processor releases the limitation and increases the maximum output to a value larger than the limit value.

2. The control device according to claim 1, wherein
when the limitation is released, the processor increases the output of the engine to a value in a high rotation speed region where a rotation speed of the engine is higher than a predetermined value, the value being larger than the output during the limitation.

3. The control device according to claim 1, wherein
when the limitation is released, the processor increases an output torque of the engine to a value in a high rotation speed region where a rotation speed of the engine is higher than a predetermined value, the value being larger than the output torque during the limitation.

4. The control device according to claim 1, wherein
when the limitation is released, the processor increases the output of the engine to a value in a depression region where an accelerator opening degree of the vehicle is larger than a predetermined value, the value being larger than the output during the limitation.

5. The control device according to claim 1, wherein
the vehicle further includes a supercharger that supercharges intake air of the engine, and
when the limitation is released, the processor increases a supercharging pressure by the supercharger to a value in a high rotation speed region where a rotation speed of the engine is higher than a predetermined value, the value being larger than the supercharging pressure during the limitation.

6. The control device according to claim 5, wherein
when the limitation is released, the processor increases the supercharging pressure to the value in the high rotation speed region, the value being larger than the supercharging pressure during the limitation, and within a range where the supercharging pressure is equal to or lower than a predetermined maximum supercharging pressure.

7. The control device according to claim 1, wherein
when the limitation is released, the processor performs a control based on a second air-fuel ratio, the second air-fuel ration being an air-fuel ratio at which at least one of an intake air amount and a fuel injection amount is larger than a first air-fuel ratio that is the target air-fuel ratio during the limitation.

8. The control device according to claim 1, wherein
the processor determines that the limitation can be released when the current position is determined to be within the predetermined area and a predetermined operation performed by a user of the vehicle is received.

9. The control device according to claim 1,
wherein the processor is configured to count the number of times the limitation is released or the number of times the engine reaches a high rotation speed region where a rotation speed of the engine is larger than a predetermined value in a state where the limitation is released, and
wherein the processor determines that the limitation cannot be released when the current position is determined to be within the predetermined area and the number of times counted by the processor exceeds a threshold value.
